(19) United States
(12) Patent Application Publication
(10) Pub. No.: US 2010/0226738 A1
(43) Pub. Date: Sep. 9, 2010

(54) Mobile Transfer System

(75) Inventors: Jon Strimling, Bedford, NH (US); Randell Drane, Winchester, MA (US); Mark MacLean, Andover, MA (US); Dan Freihofer, Lyme, NH (US)

Correspondence Address: GROSSMAN, TUCKER, PERREAULT & PFLEGER, PLLC, 55 SOUTH COMMERICAL STREET, MANCHESTER, NH, 03101, US

(73) Assignee: PELLETSALES.COM, LLC, Goffstown, NH (US)

(21) Appl. No.: 12/718,548

(22) Filed: Mar. 5, 2010

Related U.S. Application Data
(60) Provisional application No. 61/157,752, filed on Mar. 5, 2009.

(51) Int. Cl. B65G 65/32; B65G 3/04; B65G 65/34; B07B 9/00

(52) U.S. Cl. 414/293; 209/659; 209/21; 414/808

(57) ABSTRACT

A system and method for transferring bulk solid biomass fuels from a hopper to an end-user storage bin. The system may comprise at least one intermediate bulk container (IBC) configured to contain a quantity of the fuel and a mobile transfer system for transferring the fuel from the IBC to an end-user storage container. The mobile transfer system may comprise a hopper configured to be coupled to the IBC and configured to receive the bulk solid biomass fuel from the IBC; a delivery hose configured to be coupled to the hopper and the end-user storage container, wherein the delivery hose is configured to receive the bulk solid biomass fuel from the intermediate bulk container; and a blower coupled to the delivery hose, the blower configured to transfer the bulk solid biomass fuel between the intermediate bulk container and the end-user storage container. The method may comprise transferring the bulk fuel from the IBC, through the hopper and an airlock to a chamber, wherein the airlock is configured to pneumatic isolate the hopper and the chamber; coupling a delivery hose to the chamber and an end-user storage container; and providing a stream of pressurized air through the delivery hose, wherein the stream of pressurized air transfers the fuel from the hopper and the IBC to the end-user storage container.

### CROSS-REFERENCE TO RELATED APPLICATIONS

This application claims the benefit of the filing date of co-pending U.S. Provisional Patent Application Ser. No. 61/157,752, filed on Mar. 5, 2009 and entitled MOBILE TRANSFER SYSTEM, the teachings all of which are fully incorporated herein by reference.

### TECHNICAL FIELD

The present disclosure relates to a mobile system for transferring bulk (i.e., loose) biomass materials from a transportation bin to an end-user storage bin.

### BACKGROUND

Biomass heating fuels, e.g., wood pellets, may be purchased and/or transported in bags or in bulk, e.g., loose, in a transport medium. Bags may be purchased in a quantity that may then be palletized for shipping. An end-user may then receive the palletized bags and may provide the wood pellets to an appliance, e.g., pellet stove, one bag at a time. Bag sizes are not generally end-user selectable. For example, a bag may be sized to contain forty pounds of biomass pellets. This may be too heavy for some end-users to lift and/or carry. It may therefore be desirable to provide biomass fuel pellets in bulk, i.e., loose, to an end-user and provide a system for transferring bulk biomass material from a transportation bin to an end-user storage bin. The end-user may then transfer a desired quantity of biomass fuel pellets from the storage bin to the appliance.

### BRIEF DESCRIPTION OF THE DRAWINGS

These and other features and advantages will be better understood by reading the following detailed description, taken together with the drawings wherein:

FIGS. 1A-G illustrate various embodiments of a mobile transfer system consistent with the present disclosure;

FIG. 2 illustrates one embodiment of a mobile transfer system including an air classifier system consistent with the present disclosure;

FIG. 3A illustrates one embodiment of an air classifier system consistent with the present disclosure;

FIG. 3B is a close-up of region A in FIG. 3A illustrating the air classifier system of FIG. 3A consistent with the present disclosure;

FIG. 4A illustrates another air classifier system consistent with the present disclosure;

FIG. 4B is a cross-sectional view of FIG. 4A taken along lines A-A illustrating the air classifier system of FIG. 4A consistent with the present disclosure;

FIG. 5A illustrates yet another air classifier systems consistent with the present disclosure;

FIG. 5B illustrates yet a further air classifier systems consistent with the present disclosure; and

FIG. 6 illustrates a further mobile transfer system including a vacuum mobile transfer system consistent the present disclosure.

FIGS. 7 and 8 illustrate various embodiments of an arm safety feature consistent with the present disclosure;

FIGS. 9-12 illustrate a reel handler consistent with the present disclosure;

FIG. 13 illustrates a system for transferring bulk material using a conveyer or auger; and

FIGS. 14-17 illustrate a method of distributing/delivering material from distribution centers to customers utilizing a mobile transfer system as described herein.

### DETAILED DESCRIPTION

By way of an overview, a mobile transfer system consistent with at least one embodiment herein may be configured to allow a seller (e.g., a retailer) to easily transport a quantity of material to an end-user's site (e.g., a storage bin and/or other point of use locations such as, but not limited to, an animal stall or the like) at a user's location. For example, the mobile transfer system may be used to transport and transfer bulk, solid biomass fuel of other bulk material such as, but not limited to, corn, bedding material or the like into a storage bin, container, animal stall or the like. The mobile transport system may be used to transfer fuel to an end-user's site (e.g., storage bin) where the fuel may be transported to a user's appliance (such as, but not limited to, a pellet stove or the like), for example, using a self-filling pellet hod system as described in U.S. Provisional Patent Application Ser. No. 61/157,766, filed Mar. 5, 2009 and entitled SELF-FILLING PELLET HOD SYSTEM, and U.S. patent application Ser. No. ______, filed on ______ and entitled SELF-FILLING PELLET HOD SYSTEM, both of which are fully incorporated herein by reference.

Aspects of the present disclosure relate to transporting and/or transferring bulk, i.e., loose, pelletized and/or granularized solid material to an end-user's site (e.g., a user's storage bin, a horse stall, or the like). The material may include any pelletized and/or granularized solid material such as, but not limited to, pelletized and/or granularized solid bedding material for animals as well as pelletized and/or granularized solid fuel. For example, the pelletized and/or granularized solid fuel may include, but is not limited to, coal (e.g., anthracite coal) and biomass fuel. As used herein, biomass fuel is intended to refer to solid animal matter and/or solid fuel plant (such as, but not limited to, numerous types of plants including miscanthus, switchgrass, hemp, corn, poplar, willow, sorghum, sugarcane, a variety of tree species, and/or torrefied biomass fuel, e.g., e-coal or eco-coal) that can be combusted as fuel. The term biomass fuel is not intended to refer to fossil fuels which have been transformed by geological processes into substances, such as coal, petroleum or natural gas. Although fossil fuels have their origin in ancient biomass, they are not considered biomass fuel as used herein and by the generally accepted definition because they contain carbon that has been “out” of the carbon cycle for a very long time. Bulk as used herein may refer to a quantity loose of fuel that is not associated with a fixed size, e.g., forty pound bag. In other words, the material may be loose and not in bags. Although, reference is made to biomass fuel (e.g., wood pellets) in the following embodiments described below, one or more mobile transfer systems consistent with the present disclosure may be used to transport and/or transfer any bulk pelletized and/or granularized solid material.

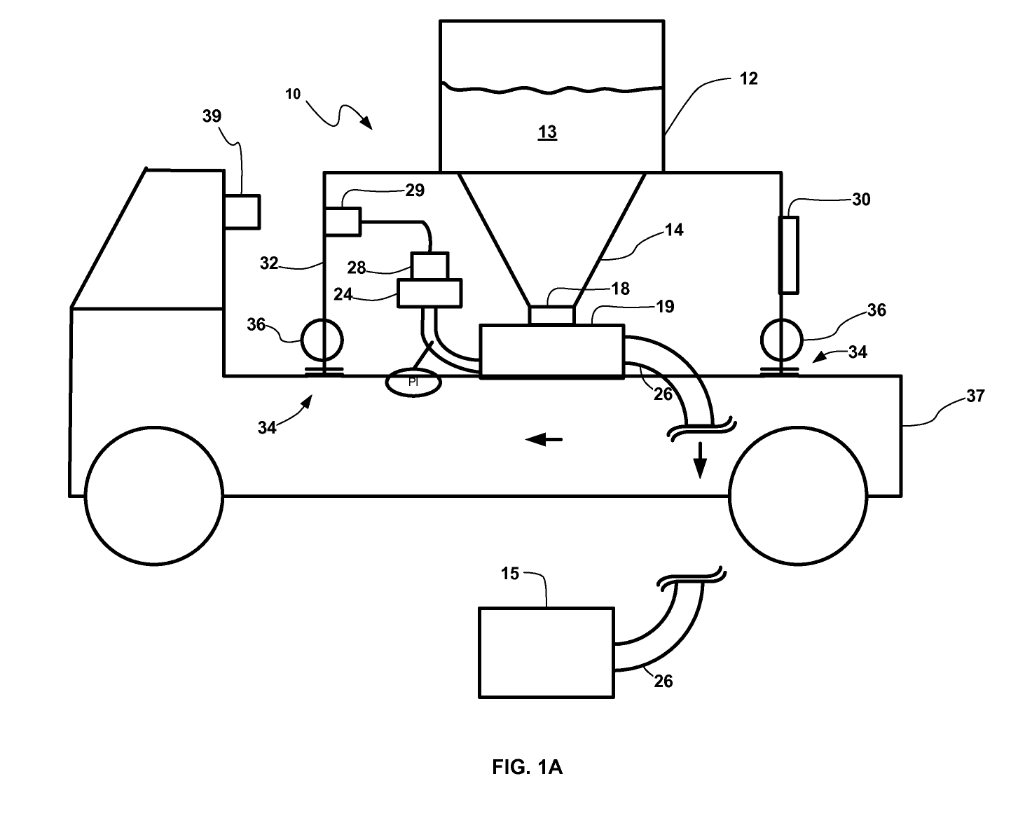

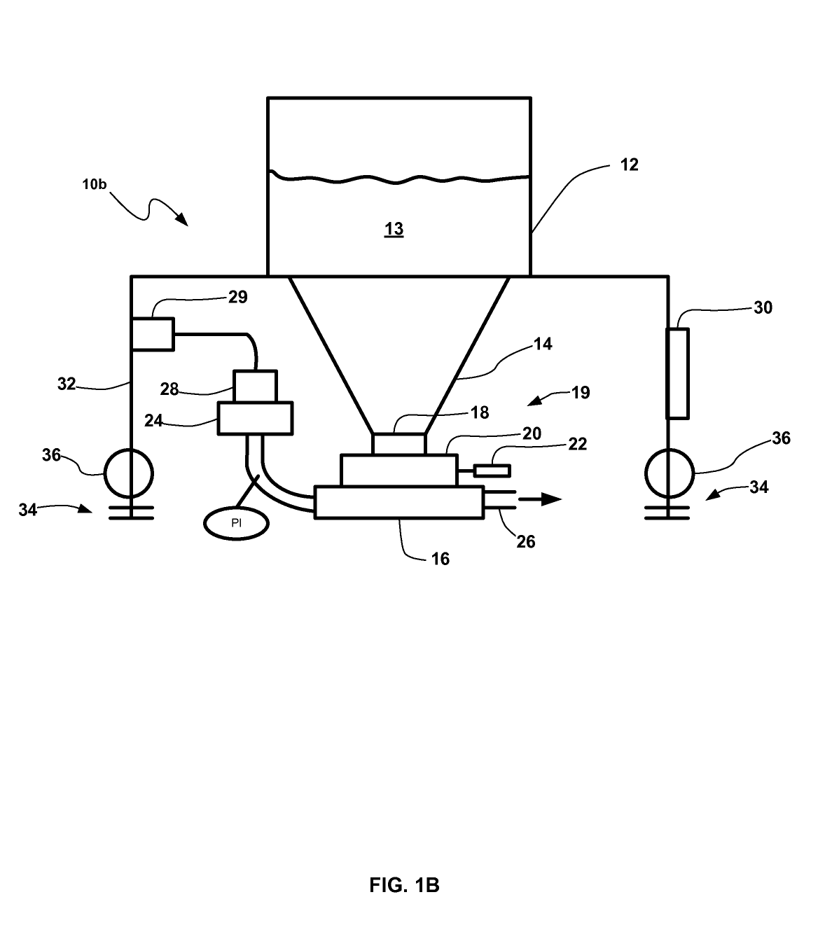

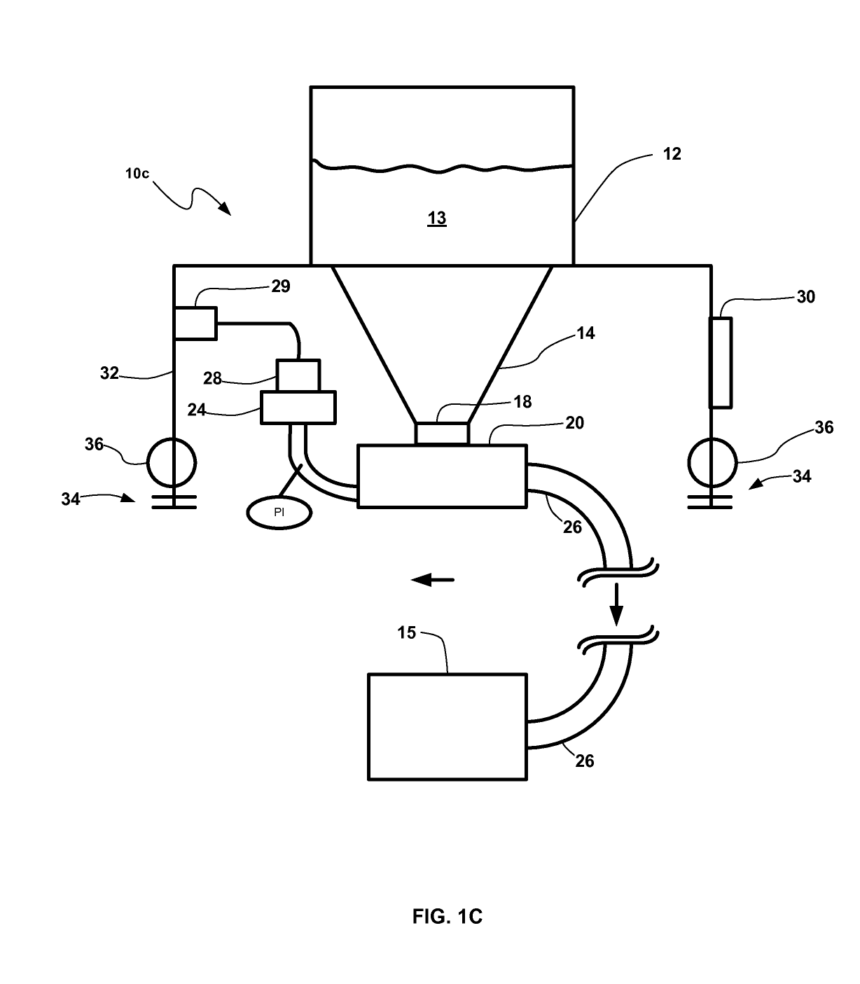

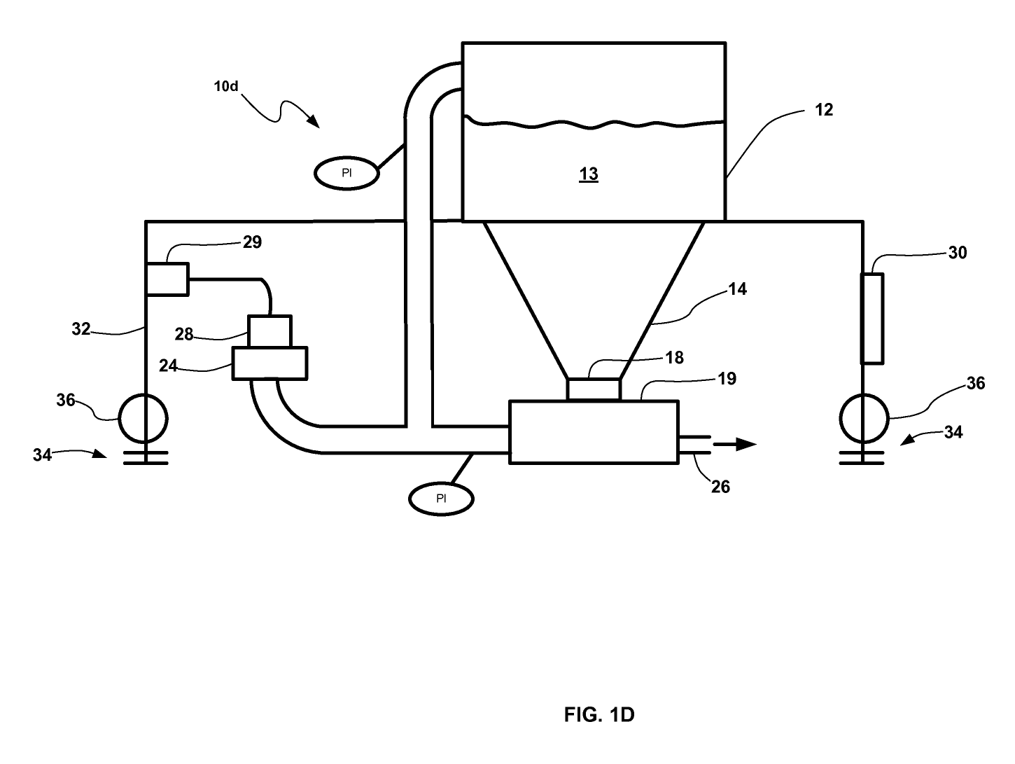

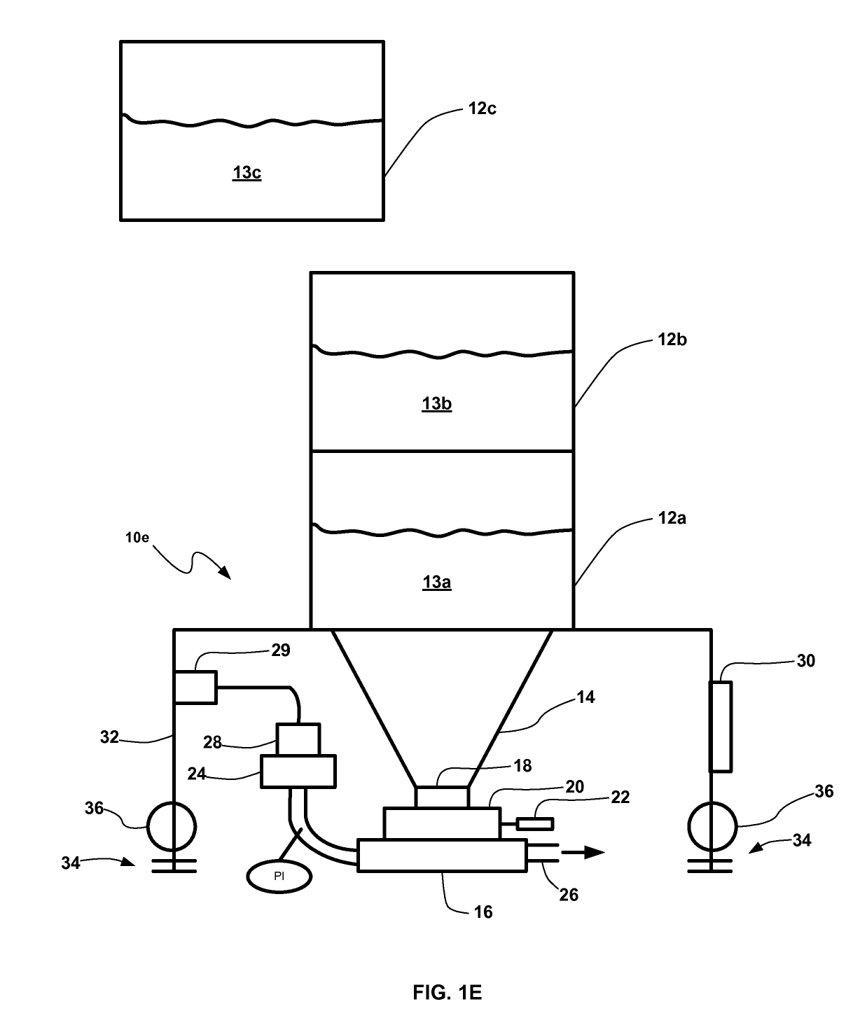

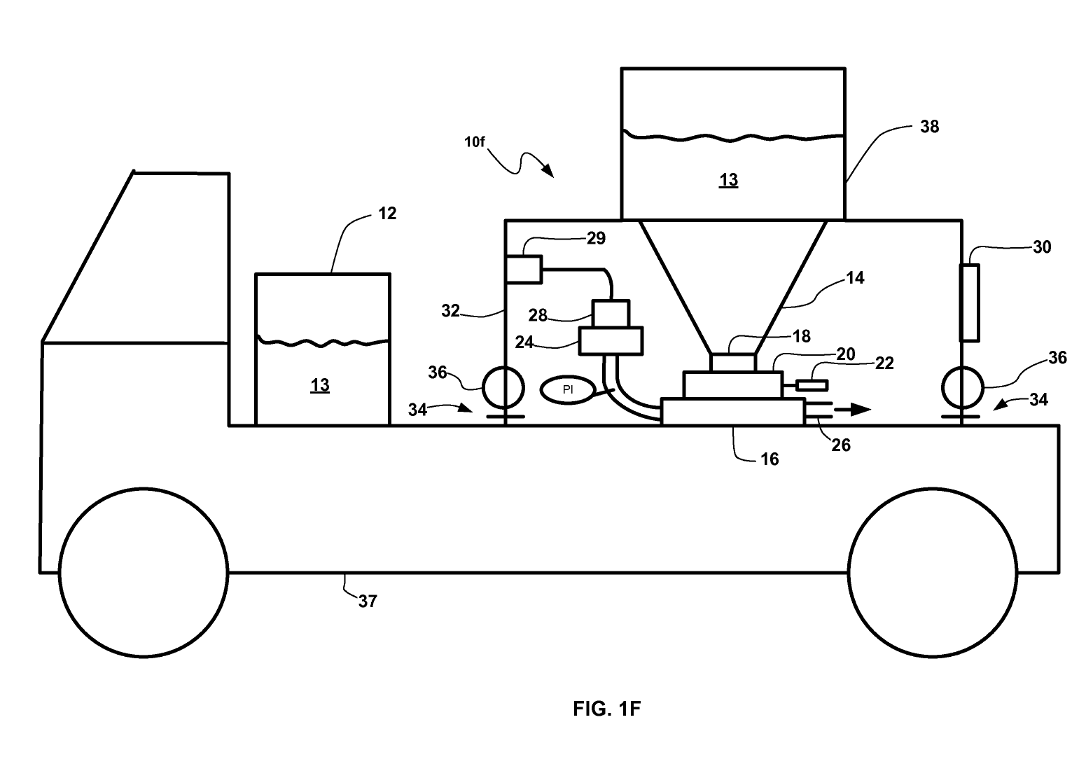

Turning now to FIG. 1A, one embodiment of an exemplary mobile transfer system 10 consistent with the present disclosure is generally illustrated. The mobile transfer system 10 may be removably coupled to a vehicle 37 (such as, but not limited to, a truck, fork lift, or the like) and may include one or more intermediate bulk containers 12. The intermediate bulk container 12 may be configured to hold a relatively large quantity of bulk, granularized solid material (e.g., biomass fuel 13). The mobile transfer system 10 may be configured to be coupled to a variety of intermediate bulk containers (IBCs) 12, which may include the same and/or different types of bulk, pelletized solid material (such as, but not limited to, different grades of fuel, different types of fuel including various types of biomass fuels, and/or other bulk, granulized solid material such as animal bedding or the like).

The intermediate bulk container 12 may include one or more bins, super sacks and frames, or other intermediate bulk containers 12. As noted herein, the intermediate bulk container 12 may be configured to hold a relatively large amount of material 13 (for example, but not limited to, one ton) of bulk fuel 13. The exact amount of material 13 stored in the intermediate bulk container 12 may depend upon a variety of factors, including the weight capacity of the vehicle 37, the number of intermediate storage containers 12 to be transported, as well as customer demand considerations. The intermediate bulk container 12 may be filled with material 13 (e.g., but not limited to, wood pellets or the like) prior to transport to an end-user site 15. For example, the intermediate bulk container 12 may be filled from a transport vehicle when the transport vehicle arrives at the location of the end-user site 15.

The mobile transfer system 10 may include a hopper 14, an entrainer 19, and a feed valve 18 coupled between the hopper 14 and the entrainer 19. The entrainer 19 and/or the feed valve 18 may be configured to meter material 13 from the hopper 14 into the pressurized air stream from air supply 24 (e.g., a blower) and to isolate the hopper 14 from the pressurized air. The feed valve 18 may be configured to control flow of material 13 between the hopper 14 and the entrainer 19 by adjusting a position of the feed valve 18.

The material 13 and pressurized air may exit the entrainer 19 through a delivery hose 26. A pressure indicator PI may be coupled between the blower 24 and the entrainer 19. The blower 24 may be driven by an engine and/or a hydraulic motor 28 coupled to a power source 29 (e.g., but not limited to, a fuel tank and/or batteries). The blower 24 may also be located remotely, and pressurized air fed to the mobile transfer system 10. In particular, the blower 24 may be located and driven by a truck or forklift 37 in the vicinity of the delivery. A rotational speed of the engine 28 may be controllable and may be configured to affect an air flow and/or pressure between the blower 24 and the entrainer 19 or to maintain a targeted static pressure at the blower outlet. The blower 24 may further include a clutch configured to couple or decouple the blower 24 and the engine and/or hydraulic motor 28.

The delivery hose 26 may be configured to couple the entrainer 19 to an end-user's site 15 (e.g., a storage bin or stall). The mobile transfer system 10 may optionally include a reel 30 for storage of the delivery hose 26.

The blower 28, entrainer 19 and/or delivery hose 26 may be configured to be electrically conductive. In this embodiment, the blower 28, entrainer 19 and/or delivery hose 26 may be electrically coupled to the truck (not shown) and/or a local ground wire to provide static discharge capabilities.

In an embodiment, the hopper 14, feed valve 18, and entrainer 19 may be coupled to a frame 32. The frame 32 may be configured to provide structural support to the hopper 14 and an intermediate bulk container 12 and may be removably coupled to a vehicle 37, for example, via a pallet or the like. The frame 32 may include a level adjustment mechanism 34. The level adjustment mechanism 34 may be manual or automatic. For example, the level adjustment mechanism 34 may include a screw-type structure. In another example, the level adjustment mechanism 34 may be hydraulically driven. The level adjustment mechanism 34 may be configured to level the mobile transfer system 10 to facilitate flow of the material 13 from an intermediate bulk container 12 into the hopper 14 and the entrainer 19. The level adjustment 34 may enhance stability of the mobile transfer system 10 when the intermediate bulk container 12 is coupled to the hopper 14 and/or may enhance the accuracy of load measurements for scaling the product delivered.

The frame 32 may further include load measuring mechanism 36. For example, once the mobile transfer system 10 has transferred a desired amount of material 13 to the end-user's site, the load measuring mechanism 36 may be configured to determine the quantity of material 13 transferred while at the user's location (i.e., the mobile transfer system 10 does not need to go to another location to determine the amount of material transferred). The load measuring mechanism 36 may include a load cell and/or commercial scale configured to weigh the amount of material transferred to the end-user's site accurately enough to be “legal for trade” as this term is understood in commerce.

The system 10 may optionally include a reporter mechanism 39 configured to generate a slip/invoice indicating how much material 13 was delivered to the user's end site 15. The reporting mechanism 39 may include a printer or the like and/or may include a wireless transceiver configured to send a signal to a central office or the like representative of the location and amount of material delivered there. The reporting mechanism 39 may also receive information from the central office (for example, address information and delivery information including the type of material 13, the amount of material 13, etc.).

As noted herein, the mobile transfer system 10 may be used to deliver a quantity of material 13 (e.g., fuel) to a residence or other end-user site 15. For example, one or more intermediate bulk containers 12 containing bulk biomass fuel 13 may be loaded on a vehicle 37 (e.g., a truck). A mobile transfer system 10 may also be loaded on the vehicle 37. The mobile transfer system 10 may be configured to be releasably coupled to the vehicle 37 by a forklift (not shown). The forklift may be configured to be loaded on and/or attached to the truck. For example, the forklift may comprise a truck mounted forklift or the like. The vehicle 37 may then be driven to the location of the end-user site 15.

The forklift may then be unloaded and/or detached from the vehicle 37. The mobile transfer system 10 may then be unloaded from the vehicle 37 using the forklift. The mobile transfer system 10 may then be positioned relative to the user's end site 15 (e.g., a biomass fuel storage bin). The adjustment mechanism 34 may adjust the mobile transfer system 10 so that the mobile transfer system 10 is substantially level. The intermediate bulk container 12 (including material 13) may then be removed from the vehicle 37 and positioned on the mobile transfer system 10 so that an outlet of the intermediate bulk container 12 is substantially aligned with the hopper 14. For example, the forklift may be used to move the intermediate bulk container 12. The outlet of the intermediate bulk container 12 may then be opened to allow the material 13 to flow from the intermediate bulk container 12 into the hopper 14. This may happen automatically when the intermediate bulk container 12 is loaded onto the hopper 14, through either an electrical signal generated from a connection or a mechanical linkage.

A first end of the delivery hose 26 may then be coupled to the entrainer 19 and a second end of the delivery hose 26 may be coupled to the end-user storage bin 15 (e.g., a biomass fuel storage bin or directed at the desired location for delivery of the material 13 if delivered to an open area, such as, but not limited to, a horse stall or the like for use as bedding). Additionally or alternatively, the delivery hose 26 may be coupled to the entrainer 19 prior to transport. The motor 28 may then be engaged and the feed valve 18 may be opened to begin flow of the material 13 from the intermediate bulk container 12 to the end-user storage bin 15. Additionally or alternatively, the blower 24 may be driven hydraulically from the vehicle 37. For example, the vehicle 37 may include a hydraulic pump coupled to and driven by the truck engine.

One embodiment of an entrainer 19 which may be used with a mobile transport system 10b is generally illustrated in FIG. 1B (the vehicle 37 is not shown for brevity). For example, the entrainer 19 may include an airlock 20 which may be coupled between the hopper 14 and a chamber 16. The airlock 20 may further include an auger. According to one embodiment, the airlock 20 may not provide a complete seal and the sealing may be accomplished with a long loaded auger, rather than with a positive seal. The airlock 20 may be configured to move material 13 from the hopper 14 to the chamber 16 while providing full or partial pneumatic isolation between the hopper 14 and the chamber 16. The airlock 20 may be driven by an air actuated, electric and/or hydraulic motor 22. The rotational speed of the airlock 20 may be adjustable. The feed valve 18 may be configured to control flow of fuel 13 between the hopper 14 and the chamber 16 by adjusting a position of the feed valve 18. The chamber 16 may be coupled to the blower 24 and a delivery hose 26.

Another embodiment of an entrainer 19 which may be used with a mobile transport system 10c is generally illustrated in FIG. 1C. The entrainer 19 is substantially similar to the entrainer 19 illustrated in FIG. 1B except that the chamber 16 has been eliminated. In particular, the pressurized air flows directly into the airlock 20 (for example, but not limited to, a bottom portion of he airlock 20). The material 13 may be metered from the hopper 14 by controlling feed valve 18.

Yet another embodiment of the entrainer 19 which may be used with a mobile transport system 10d is generally illustrated in FIG. 1D. The IBC 12 and/or the hopper 14 may be pressurized, for example, by diverting some of the pressurized air from the blower 24 to the IBC 12 and/or the hopper 14. As a result, the need for an airlock may be avoided. The material 13 may flow from the hopper 14, through the feed valve 18 which may regulate the flow rate, and into an entrainer 19 where it may be mixed with the pressurized air. The air and material 13 may then enter the delivery hose 26.

Turning now to FIG. 1E, the intermediate bulk container 12 may be configured to be nested. In other words, a first IBC 12a may be positioned on the mobile transfer system 10e. A second IBC 12b may be positioned on the first IBC 12a, e.g., on top of the first IBC 12a, so that material 13b in the second IBC 12b may flow into the first IBC 12a and then into the hopper 14 for conveyance to the end-user storage bin. Typically, material 13b flows more quickly from the second IBC 12b into the first IBC 12a than from the first IBC 12a to the end-user storage bin. While the second IBC 12b is coupled to the first IBC 12a, a third IBC 12c may be retrieved from the vehicle. The second IBC 12b may be removed when it is empty and may be replaced by the third IBC 12c. This may allow a faster transfer of material 13 from an IBC 12 to the end-user storage bin than would be possible using only one IBC 12 at a time. The various IBCs 12a-12c may also contain different types and/or grades of fuel and/or material 13.

In yet another embodiment, the IBC 12 may be integral to the truck 37 as generally illustrated in FIG. 1F. In this embodiment, the mobile transfer system 10f may include a container 38 coupled to the hopper 14 that may be filled from the bulk storage bin 12 at the end-user site. For example, a conveyor, auger or blower system (for example, as described herein) may be used to load the container 38 in the mobile transfer system 10f from the bulk storage bin 12 on the truck 37. The loaded mobile transfer system 10f may then be decoupled from the bulk storage bin 12 and moved to a position for coupling to the end-user storage bin. Delivery of the material 13 may then be accomplished using an auger and/or blower, for example, as described herein.

In another embodiment, the mobile transfer system 10g may be integrated with the forklift or other driven machinery as generally illustrated in FIG. 1G. In yet another embodiment, the mobile transfer system 10g may be configured to be self-propelled vehicle 150 so that it may be positioned at an appropriate delivery site. The self-propelled vehicle 150 may be configured to be releasably coupled to the primary vehicle 37 (e.g., truck) and may include a motor which may power a blower 24 as well as provide locomotion means (e.g., to wheels 151a-151n). The self-propelled vehicle 150 may also include a hopper 14, measuring devices 36, a valve 18 and an entrainer 19 as generally described herein. Optionally, the self-propelled vehicle 150 may include one or more hose reels 30. The self-propelled vehicle 150 may be filled (e.g., during transport while on the vehicle 37) from one or more intermediate bulk containers 12 or other containers containing material 13 prior to arriving at a delivery site.

Any of the mobile transfer systems 10 described herein may include a vacuum line configured for recovering ashes from an ash receptacle. The ash receptacle may be located at a residential or commercial end-user site. The mobile transfer system 10 may be configured to provide the recovered ashes to an ash storage bin in the mobile transfer system 10. In an embodiment, the ash storage bin may be removable. The mobile transfer system 10 may include measures to minimize fire hazards.

Any of the mobile transfer systems 10 described herein may also be powered by gas produced by gasifying a biomass fuel 13 being delivered by the mobile transfer system 10. In yet another embodiment, the gas may be produced by gasifying particulate that may be recovered from the biomass fuel 10. The mobile transfer system 10 may include an engine configured to consume the gas to power the airlock, auger and/or blower. In an embodiment, the self-propelled mobile transfer system may be configured to be powered by this gas.

In yet another embodiment, the mobile transfer system described herein may include an engine or motor configured to move the mobile transfer system. The engine or motor may be further configured to power a conveying system, i.e., system for conveying biomass heating fuels. The conveying system may include a blower, an auger and/or a conveyor belt.

The mobile transfer systems described herein may optionally include a classifier (i.e., dust filtration system) configured to separate fine particles (“fines” or “dust”) from the biomass fuel 13 (e.g., but not limited to, pellets). Separation of such fine particles from the pellets 13 may mitigate a fire hazard and/or improve the quality of the delivered product. As used herein, the term “fines” is intended to refer to particles which may flow through a ¼″ mesh screen. For example, fines may include particles which may flow through a generally square 3/16″ opening or a ⅛″ screen.

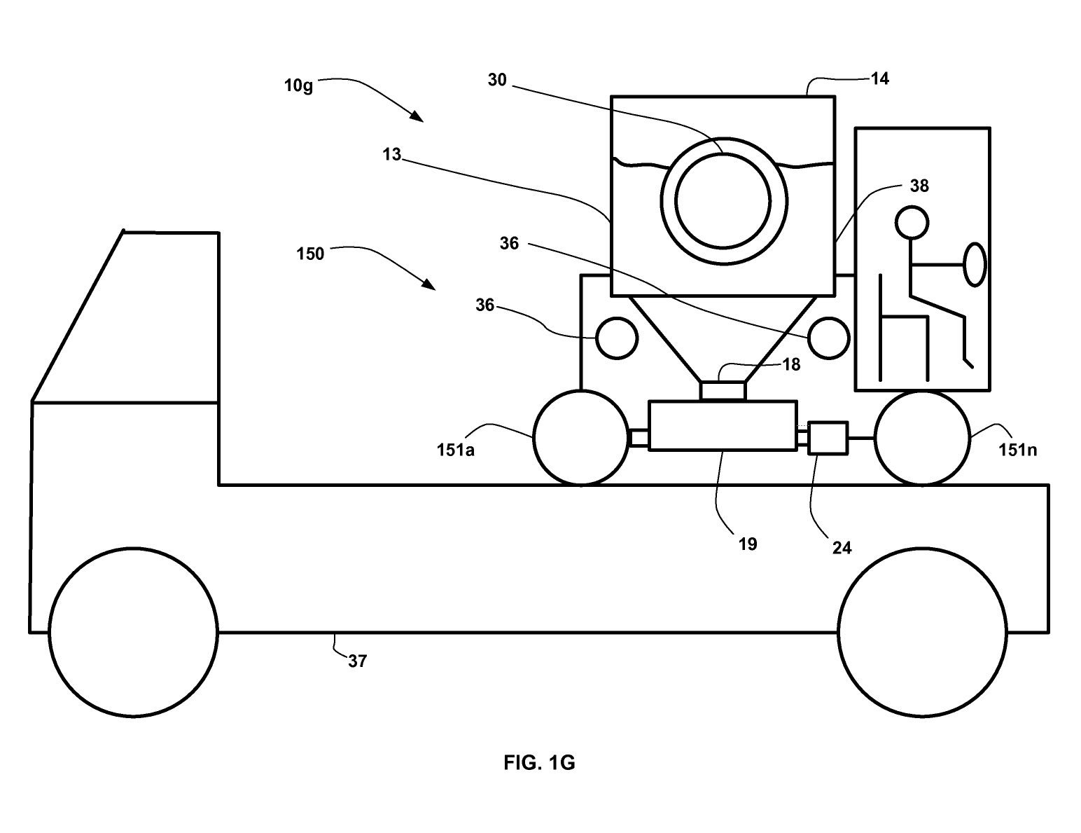

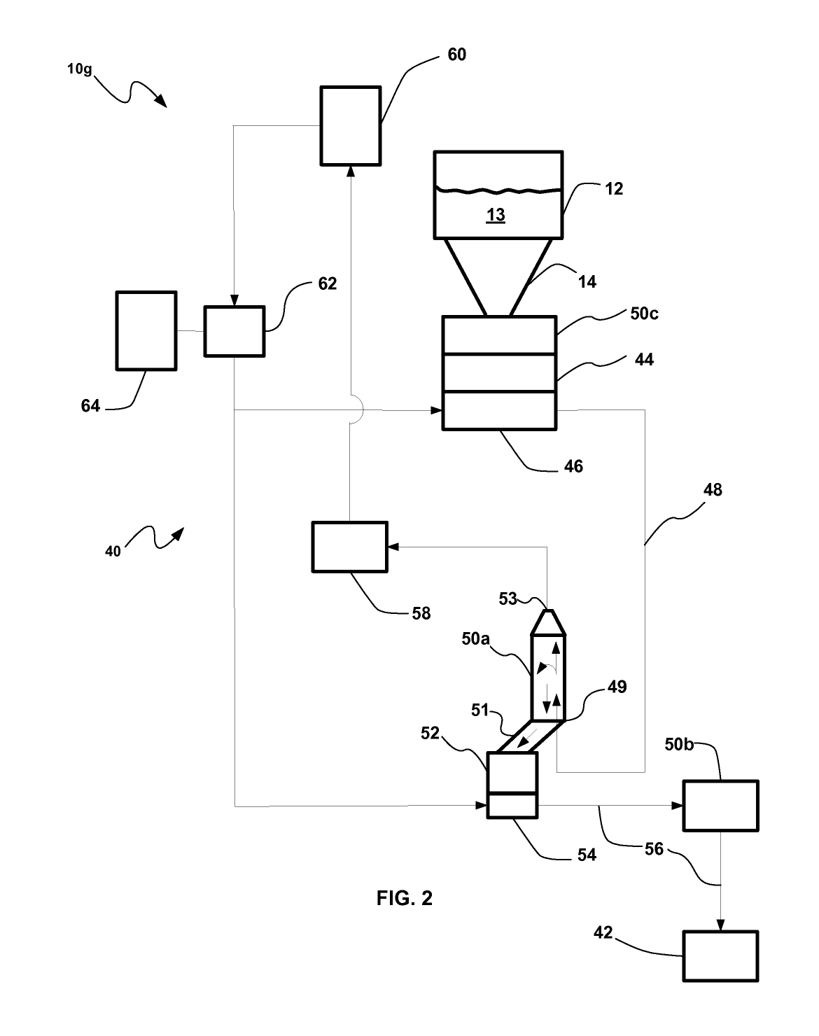

Turning now to FIG. 2, one embodiment of a mobile transfer system 10g including a classifier system 40 is generally illustrated. The fines may be separated from the material 13 (e.g., fuel such as, but not limited to, pellets) using a screening process during the transfer of the biomass pellets 13. The classifier system 40 is described in terms of separating fines from pellets 13, but it should be appreciated that the classifier system 40 may remove fines from any bulk, granularized material. The classifier system 40 may include one or more classifiers 50a positioned between a pellet source (e.g., IBC 12) and a storage container 42 or end user location (such as, but not limited to, a horse stall or the like). Additionally (or alternatively), the classifier system 40 may include one or more classifiers 50b positioned between a end user's storage bin 42 and the delivery hose 56 and/or within the user's storage bin 42.

For example, pellets 13 (including dust and/or fine particles) may flow from a pellet feed (e.g., an IBC 12 and a hopper 14) through a first airlock 44 into a chamber 46 then to a first hose 48. The fuel 13 and fines may flow through the first hose 48 to an inlet 49 of the classifier 50a. The classifier 50a may be configured to generally separate the fines from the fuel 13. The fuel 13 (without the fines) may exit the classifier 50a through a fuel outlet 51 of the classifier 50a. The fuel outlet 51 may be coupled to a second airlock 52 and a second chamber 54. The fuel 13 may flow from the fuel outlet 51, into the second airlock 52 (which may be configured to isolate the classifier 50a from the blower 62) and into the second chamber 54. The second chamber 54 may be coupled to the outlet of the blower 62 and may entrain the fuel 13 with the air stream from the blower 62. The air and fuel 13 may then exit the second chamber 52 via a delivery hose 56, which may ultimately be coupled to a storage container, e.g., an end-user storage bin 42 or end user location (such as a horse stall). The air and fines separated from the fuel 13 in the classifier 50a may exit the classifier 50a via the air/fine outlet 53. The air/fine outlet 53 of the classifier 50a may be coupled to a filter 58, filter silencer 60 and/or the blower 62 (which may be powered by a motor 64).

As noted herein, the classifier system 40 may include one or more classifiers 50b positioned between a user's storage bin 42 and the delivery hose 56 and/or within the user's storage bin 42. The classifier 50b may function similar to the classifier 50a described herein.

As noted above, the classifiers 50a, 50b may include an air classifier. Alternatively (or in addition), one or more of the classifiers 50a, 50b may include a vibratory, a gravity screen or another type of classifier which may or may not use air. In another embodiment, a classifier 50c may optionally be positioned between the pellet feed 12 and the first airlock 44 and first chamber 46. This embodiment may not include the second airlock 52.

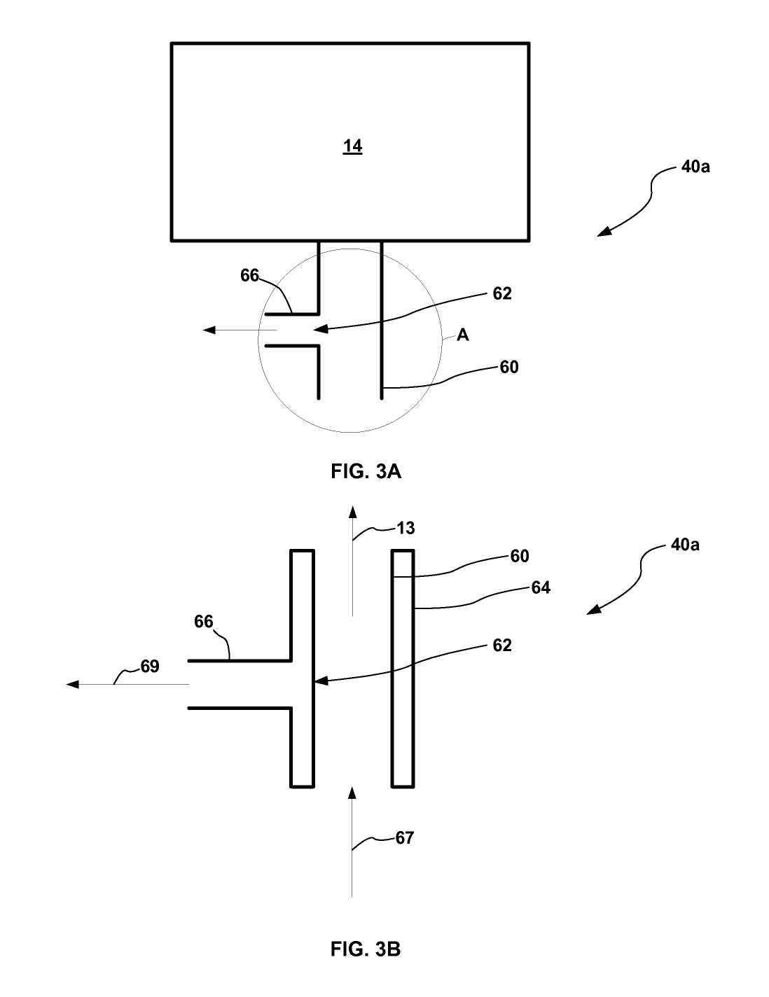

Turning now to FIGS. 3A and 3B, two views of another exemplary classifier 40a are generally illustrated. FIG. 3A illustrates an example of a classifier 40a positioned at an inlet to a hopper 14. FIG. 3B is a detail view of the classifier 40a as illustrated in circle A of FIG. 3A. The classifier 40a may include a pipe 60. The pipe 60 may have a perforated wall portion 62 (e.g., a perforated screen). The perforated wall portion 62 may be surrounded by a chamber 64 and the chamber 64 may have an outlet 66. Pellets, air and/or dust 67 may flow into the pipe 60 (from the bottom as oriented in the figure) from, e.g., an IBC 12 (not shown). A negative pressure (e.g., a vacuum) may be applied to the outlet 66. Dust and/or air 69 may flow through the perforated screen 62 and out the outlet 66 thereby being separated from the pellets 13. The perforated wall portion 62 may be configured to prevent pellets 13 from passing through it. Pellets 13 and/or air may then flow into the hopper 14. Alternatively, the pellets may enter from the top and flow out the bottom and air may enter from the bottom and leaves through the top and the side.

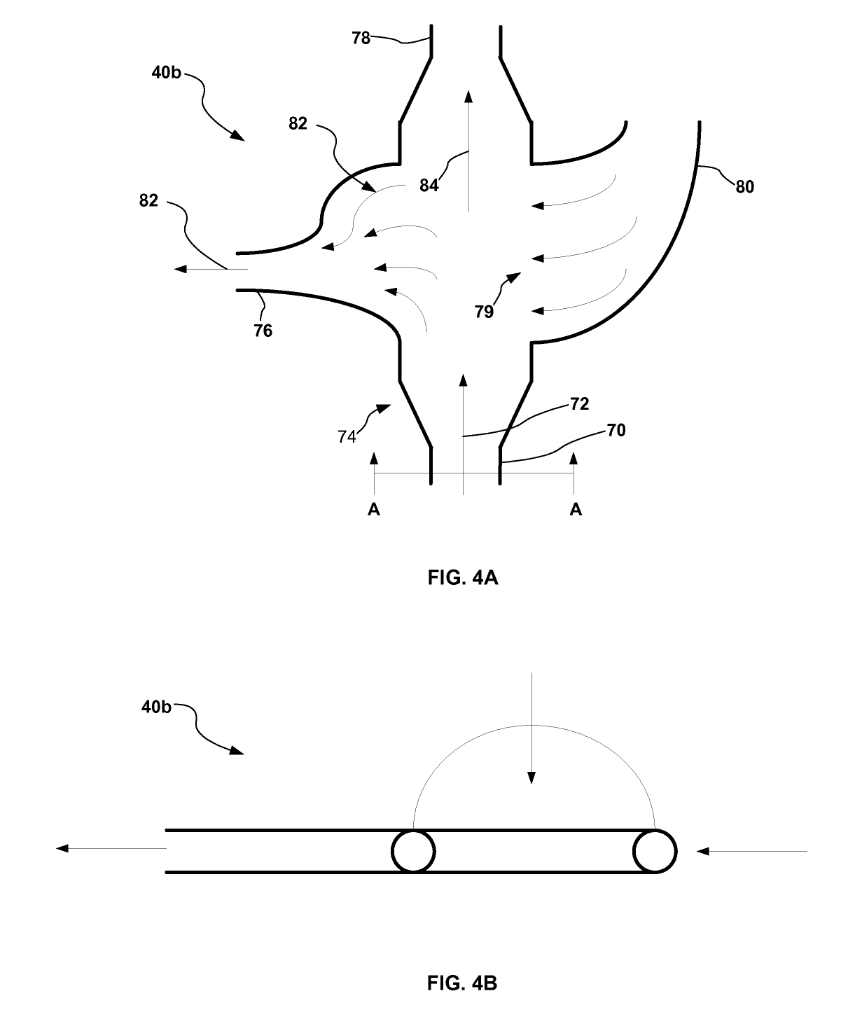

FIGS. 4A and 4B are two views of an exemplary horizontal classifier 40b. The horizontal classifier 40b may include an inlet 70 for pellets, dust, and air 72, an air diffuser 74, a vacuum outlet 76, a pellet outlet 78 (e.g., to a hopper, not shown) and/or an air inlet 80 (e.g., from the hopper). Pellets, dust, and air 72 may flow into the horizontal classifier 40b via the air diffuser 74 (e.g., from the bottom as oriented in FIG. 4A). Dust and/or light (e.g, small) pellets 82 may flow out of the vacuum outlet 76 while relatively larger and/or heavier, pellets 84 may flow out through the pellet outlet 78 and air 79 may flow in from the air inlet 80. As should be understood by one of skill in the art, the horizontal classifier 40b is configured to separate dust and fines 82 from pellets 13 using airflow (vacuum) and an air diffuser 74. Alternatively, the pellets may enter from the top and flow out the bottom and air may flow generally horizontally across.

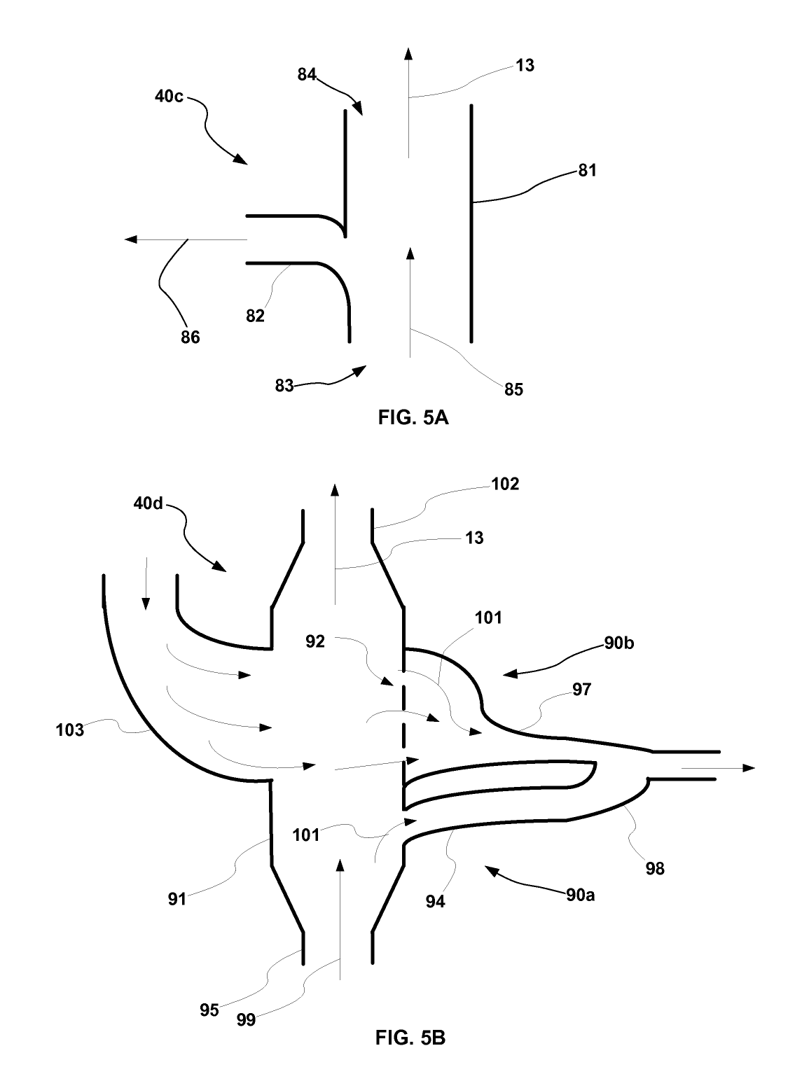

FIGS. 5A and 5B illustrate two more classifiers 40c, 40d. The classifier 40c shown in FIG. 5A may include a pipe 81 and an elbow 82 that coupled to the pipe 81. The pipe 81 may include inlet 83 and an outlet 84. Pellets, air and dust 85 may flow into the pipe inlet 83. Air and dust 86 may be separated from the pellets 13 and may flow out the elbow 82. For example, the elbow 82 may be coupled to a vacuum source. The remaining pellets 13 and air may then flow out of the pipe outlet 84.

The classifier 40d shown in FIG. 5B may include two stages, 90a, 90b. The classifier 40d may include a pipe 91. The first stage 90a of the classifier 40d may include an elbow 94 coupled to the pipe 91. The second stage 90b may include a section of screened, i.e., perforated, wall and/or a cutout section 92. For example, the elbow 94 may be coupled to the pipe 91 prior to the second stage 90b (e.g., prior to the section of screened wall 92) and may be disposed closer to an inlet 95 to the pipe 91. In this example, the elbow 94 may provide an initial stage 90a and the screened wall portion 92 may provide an additional stage 90b. A chamber 97 (including an inlet and an outlet) may surround the screened wall section 92. An output 98 of the elbow 94 may be coupled to the outlet of the chamber 97, and both may be coupled to a vacuum source. Pellets, air and/or dust 99 may flow into an inlet 95 of the pipe 91. Air and/or dust 101 may flow into the elbow 94 and/or through the screened wall 92 and out toward the vacuum source. Pellets 13 may flow in the pipe 91 to an outlet 102 and then to a storage container (e.g., a storage silo or the like, not shown). The chamber 103 inlet may be coupled to the storage container, providing an air source.

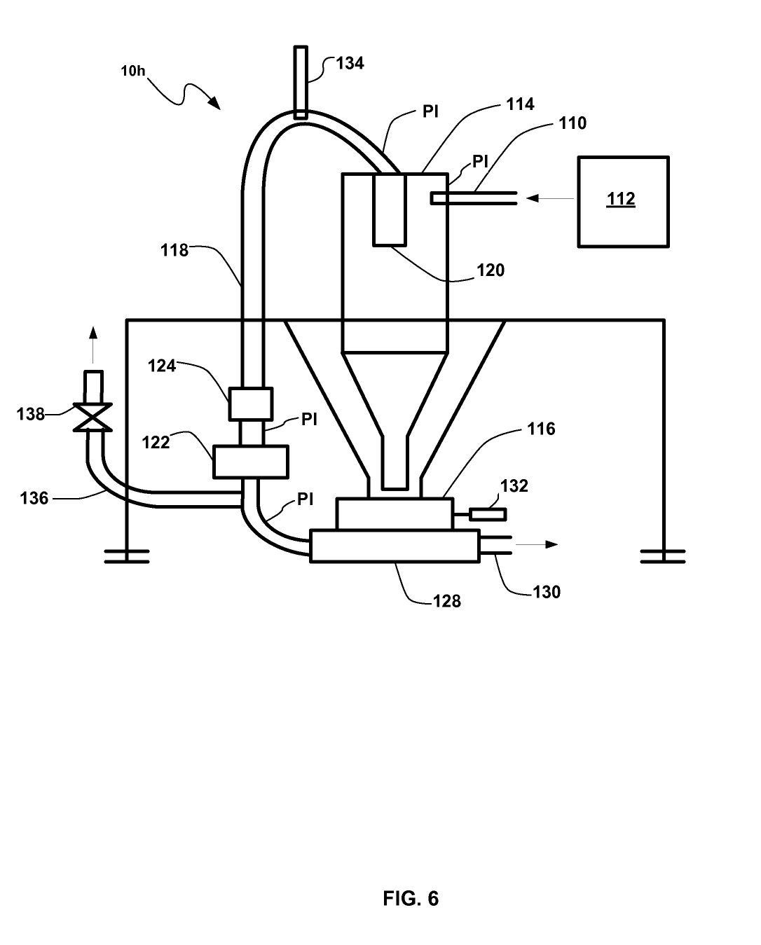

Turning now to FIG. 6, another exemplary mobile transfer system 10h consistent the present disclosure is generally illustrated. The mobile transfer system 10h may be configured to provide a vacuum, i.e., negative pressure to remove material 13 (e.g., biomass fuel such as, but not limited to, pellets and/or fines) from an end-user storage site 112. The vacuum mobile transfer system 10e may include a vacuum hose 110 coupled between the end-user's site 112 and a cyclonic separator 114. The cyclonic separator 114 may be used to separate relatively heavier, larger particles (e.g., pellets 13) from fines (e.g., dust and the like) using vortex separation rather than filters. The cyclonic separator 114 may be coupled to an airlock 116 configured to receive the relatively larger, heavier particles (e.g., biomass fuel pellets 13). The cyclonic separator 114 may be further coupled to a source vacuum hose 118 through a first stage filter 120. The source vacuum hose 118 may be coupled to a blower 122 through a filter silencer 124. The blower 122 may be coupled to a chamber 128. The chamber 128 may be coupled to the airlock 116 and a receiving hose 130. The receiving hose 130 may be coupled to a bulk container (not shown).

The vacuum mobile transfer system 10h may further include one or more pressure indicators PI, positioned for example, in the cyclonic separator 114, in the source vacuum hose 118 adjacent the first stage filter 120, in the source vacuum hose 118 between the filter silencer 124 and the blower 122 and/or between the blower 122 and the chamber 128. Similar to the mobile transfer system 10 of FIG. 1, the airlock 116 may be coupled to an electric or hydraulic motor 132 and the blower 122 may be coupled to an engine and/or hydraulic motor (not shown).

The vacuum mobile transfer system 10h may further include a diverter valve 134 coupled to the source vacuum hose 118 and configured to allow blowing to purge the vacuum mobile transfer system 10h. The vacuum mobile transfer system 10h may further include a back pulse hose 136 coupled to the source vacuum hose 118 adjacent the first stage filter 120 and coupled to the blower 122 adjacent the chamber 128. The back pulse hose 136 may include a back pulse valve 138. The back pulse hose 136 and back pulse valve 138 may be configured to provide a pulse of positive pressure to the first stage filter 120. The pulse of positive pressure may help to dislodge particles and/or pellets that may be stuck in the vacuum mobile transfer system 10h.

The vacuum mobile transfer system 10h may be used to remove biomass heating fuel pellets from an end-user storage bin 112. Such removal may be desirable, for example, if the fuel 13 become contaminated with water. Such removal may also facilitate return of unused fuel 13 by the end-user. In an embodiment, the vacuum mobile transfer system 10h may be used to remove particles (e.g., accumulated fines) from an end-user storage bin 112 prior to conveying fuel 13 into another bin (not shown). This mobile transfer system 10h may also be used to make a two-stage transfer, for example pulling product out of a bulk bin on a truck (which may be removably coupled to the truck or might just be a built in hopper on the truck) and then to transfer (e.g., blow) the product once it drops to chamber 128 out to an end use or storage point.

During normal operation, the back pulse valve 138 may be closed and the diverter valve 134 may allow flow in the source hose 118 between the first stage filter 120 and the filter silencer 124. A first end of the vacuum hose 110 may be coupled to the cyclonic separator 114 and a second end may be placed in an end-user storage bin 112. The airlock 116 and blower 122 may be activated. The blower 122 may create a negative pressure in the cyclonic separator 114 relative to the end-user storage bin 112. Pellets and/or particles 13 may begin to flow from the end-user storage bin 112 to the cyclonic separator 114. In the cyclonic separator 114, pellets 13 may fall to an outlet of the cyclonic separator 114 and then to the airlock 116. The blower 122 may create a flow in the chamber 128. Pellets 13 reaching the chamber 128 may then be conveyed through the receiving hose 130 to the disposal bin or other bin for removal (not shown). A portion of particles flowing into the cyclonic separator 114 may be caught in the first stage filter 120 and another portion may be trapped in the filter silencer 124. Periodically, the back pulse valve 138 may be opened and the diverter valve 134 may block flow in the source hose 118 between the first stage filter 120 and the filter silencer 124. In this configuration, particles may be dislodged from the first stage filter 120 and/or particles and pellets may be dislodged from the end-user vacuum hose 110.

The mobile transfer systems and/or the vacuum remote transfer systems as described herein may optionally include remote control capability. The remote control may be wired or wireless. An operator may control rotational speeds of the airlock, blower and/or engine. The operator may further select a position of the feed valve and/or whether the blower clutch is engaged. In the vacuum mobile transfer systems, the remote control may further control a position of the diverter valve and/or a position of the back pulse valve. In some embodiments, the operator may control the level of the mobile transfer systems. In yet other embodiments, the operator may control a travel path of the mobile transfer systems, remotely.

The mobile transfer system consistent with at least one embodiment herein may eliminate the IBC. For example, a bulk bin may be coupled to a truck and a vacuum system which may also blow to another location, e.g., as generally shown in FIG. 6. In particular, if the mobile transfer system of FIG. 6 included wheels, the mobile transfer system could transfer material from a bulk hopper truck (without IBCs), drive the material to the end of the driveway at an end user's site, and then transfer (e.g., blow) the material into the end user's bin (or to a horse stall).

As discussed herein, one or more of the systems described herein may comprise one or more intermediate bulk containers 12 which may be loaded onto the top of a hopper 14. When loading material 13 from the IBC 12 to the hopper 14, it may be necessary for an operator to disconnect a portion of the IBC 12 (e.g., but not limited to, open a release valve or disconnect a super sack, not shown for clarity) in order for the material 13 to flow from the IBC 12 to the hopper 14. While this process may be performed mechanically and automatically when the IBC 12 is loaded onto the hopper 14, it may also be desirable to have this performed manually. The systems herein may include an arm safety feature to reduce the potential of an operator's arm becoming injured, for example, due to equipment failure or misuse when loading the IBC 12 onto the hopper 14.

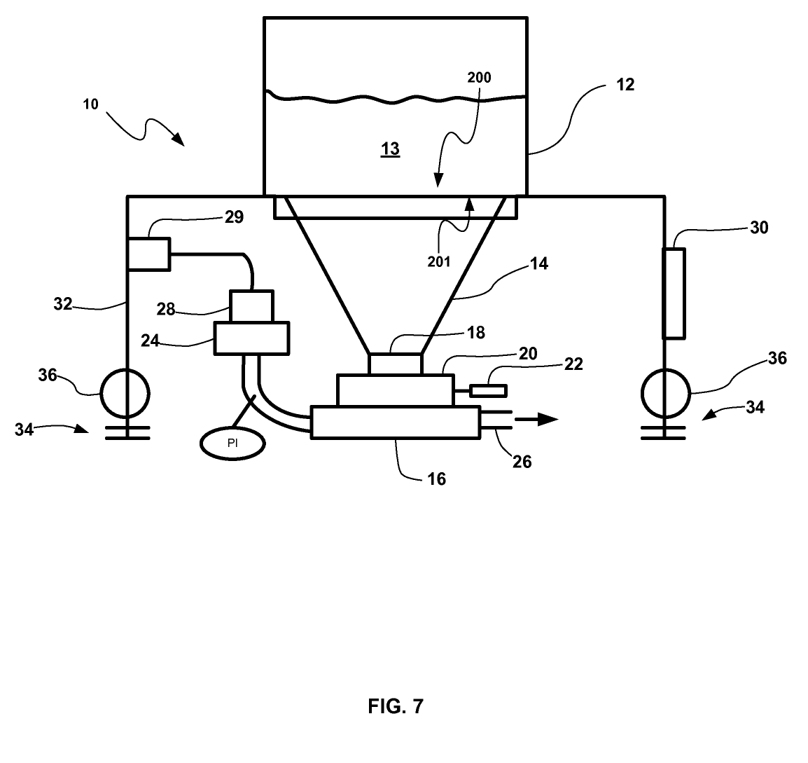

One embodiment of an arm safety feature is generally illustrated in FIG. 7. In particular, the frame 32 may include one or more recessed or notched areas 200. The notched area 200 may be disposed about a portion of the top perimeter 201 of the frame 32 proximate to the opening of the hopper 14. The notched area 200 may provide sufficient clearance for an operator's arm in the event that the IBC 12 accidentally falls against the hopper 14. The top perimeter 201 may include a single notched area 200 as illustrated, but may alternatively include multiple notched areas 201.

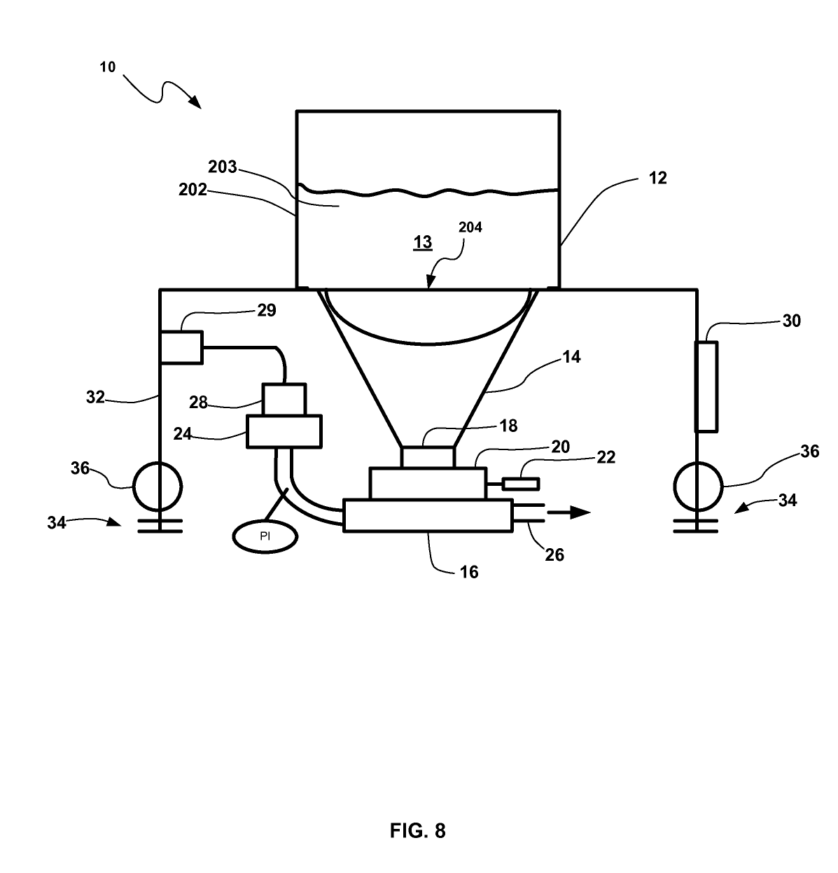

Another embodiment of an arm safety feature is generally illustrated in FIG. 8. For example, the IBC 12 may include a frame 202 configured to support a flexible container 203 (e.g., but not limited to, a canvas bag or the like). The frame 32 may be configured to provide an open region 204 in which the flexible container 203 is exposed. In the event that the IBC 12 accidentally dropped towards the hopper 14, the flexible container 203 may deform around the user's arm in the open region 204, thereby reducing damage to the user's arm.

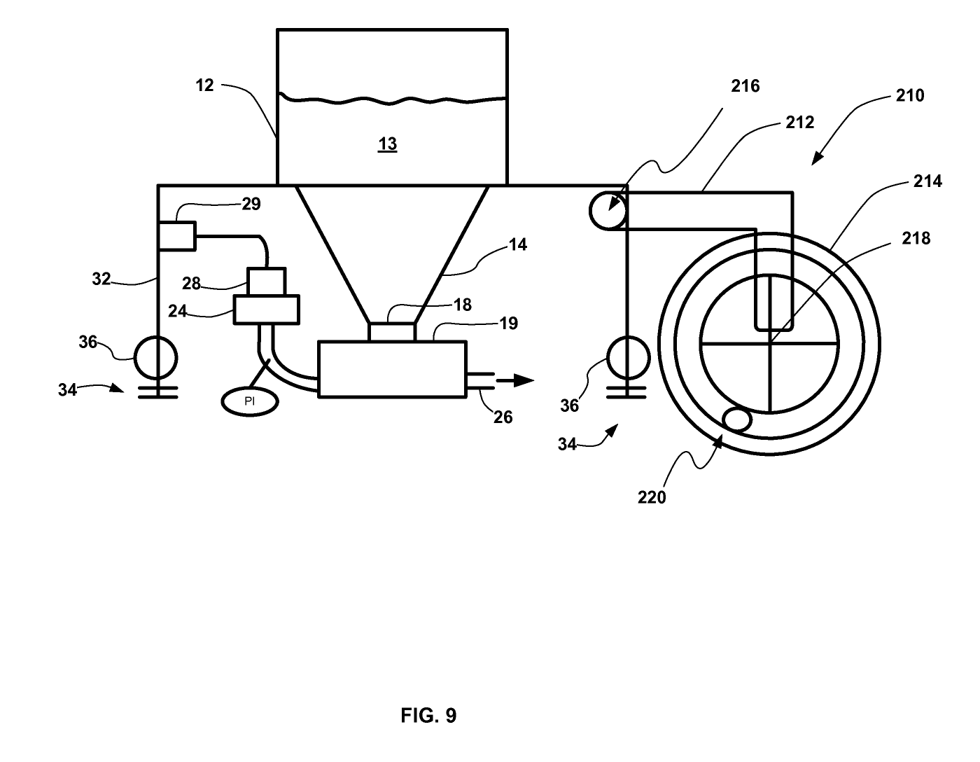

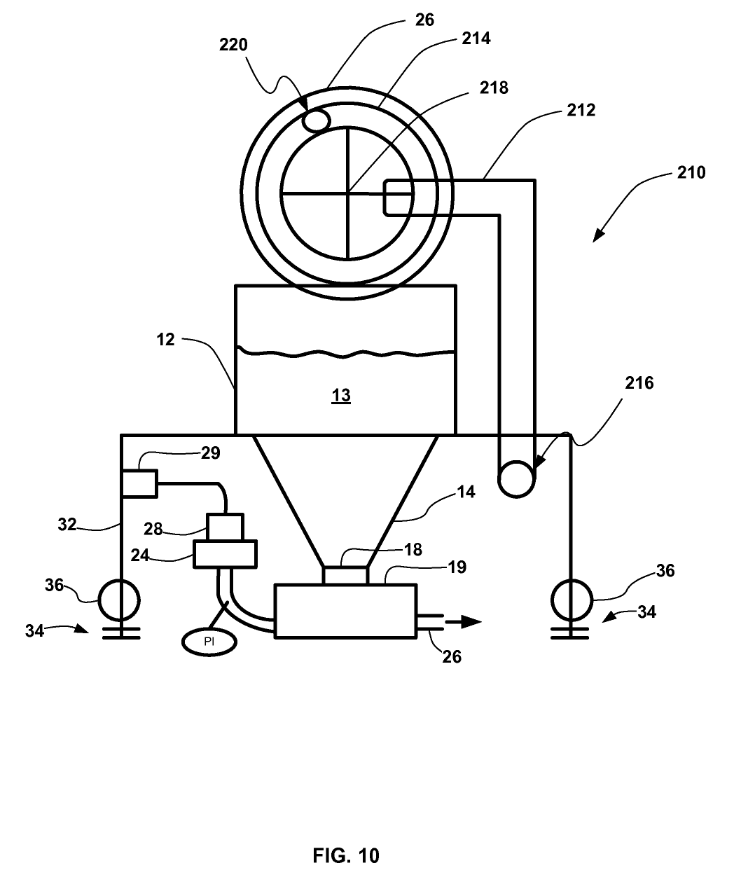

Turning now to FIGS. 9-12, a reel handler 210 is generally illustrated. In particular, the reel handler 210 may be configured to allow an operator to easily store and un-store a delivery hose (e.g., the delivery hose illustrated in FIG. 1) while at a customer's location. For example, the reel handler 210 may comprise an arm 212 configured to be releasably coupled to a reel 214. The delivery hose or a portion thereof (which may have a diameter of approximately 4″ and may be relatively inflexible) may be wrapped around one or more reels 214. The reels 214 may then be coupled to the arm 212, which may pick up the reel 214 from an initial position ground (e.g., an unloaded position as generally illustrated in FIG. 9) and move the reel 214 to a stored or loaded position (e.g., as generally illustrated in FIG. 10).

The reel handler 210 may include one or more actuators 216 (e.g., hydraulic, electric, magnet, pneumatic or the like) configured move the reel 214 between the unloaded position (FIG. 9) and the loaded position (FIG. 10). While a single actuator 216 is illustrated, it may be appreciated that the reel handler 210 may include multiple actuators 216, which may be configured to move the position of the reel 214 and/or arm 212. The reel handler 210 may also include one or more connectors 218 (e.g., a clamp or the like) configured to releasably couple the arm 212 to the reel 214. The connectors 218 may optionally be configured to disconnect the reel 214 when the reel 214 is in the loaded position (FIG. 10) so that the reel handler 210 may load/unload another reel 214 (only one of which is shown for clarity).

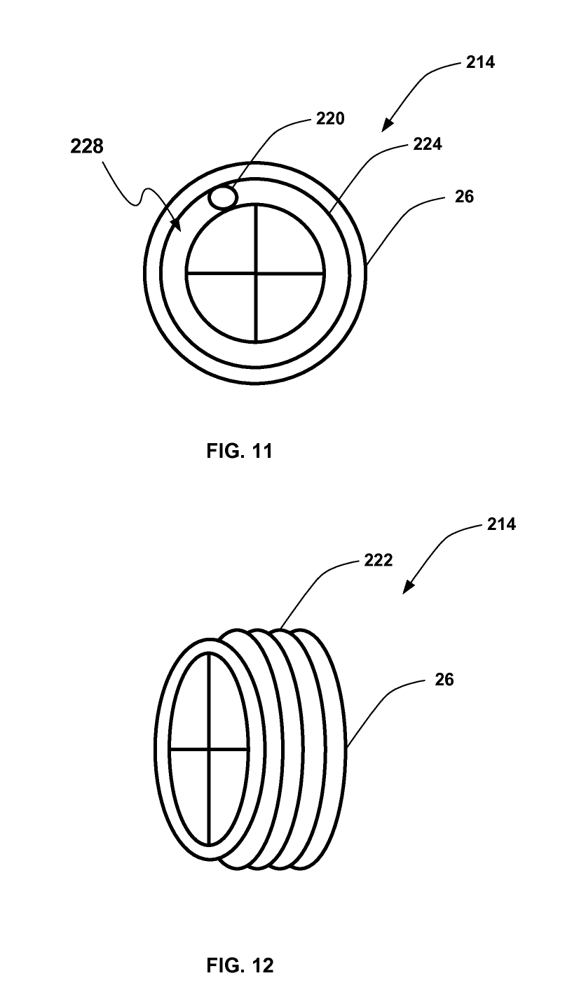

Turning now to FIGS. 11 and 12, one embodiment of a reel 214 is illustrated. The reel 214 may include a coupler 220 configured to be releasably coupled to an end of the delivery hose (not shown). The reel 214 may also include a groove 222 spiraling around an outer circumference of the reel body 224, e.g., as generally illustrated in FIG. 12. The body 224 may also include an end shroud 228, e.g., as generally illustrated in FIG. 11.

In use, the delivery hose 26 may be laid upon the ground. The operator may wind up the delivery hose by connecting an end of the delivery hose to the coupler 220 of the reel 214. The operator may then roll the reel 214 generally towards the other end of the delivery hose, and the delivery hose may be wound upon the groove 222. The second end of the delivery hose may also be coupled to a coupler 220 or otherwise secured in place.

The reel 214 (with the delivery hose wound thereon) may then be connected to the arm 212 (e.g., using connector 218). The reel 214 and delivery hose may then be moved form the unloaded position (FIG. 9) to the loaded position (FIG. 10). Once in the loaded position, the reel 214 and hose may optionally be disconnected and secured. Additional reels 214 and hose may also be stored in the same manner. The reel 214 and hose may be unloaded by reversing the process.

One benefit of the reel handler 210 is that the delivery hose (which may have limited flexibility and be heavy) may be broken into a plurality of smaller, more easily handle sections. The operator may then unload as many reels 214 as necessary to connect the delivery system 10 to the end-user's site.

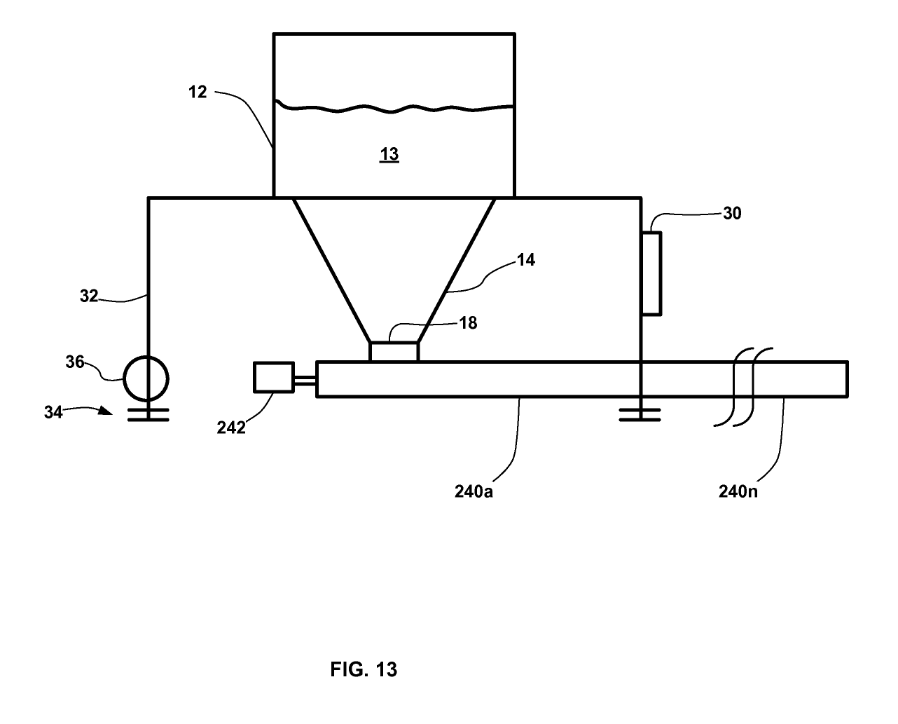

In an additional embodiment, material 13 may be transferred to an end-users' site using a conveyer or auger as generally illustrated in FIG. 13. Material 13 in the IBC 12 may be dispensed from the hopper 14 through a valve 18 and onto a conveyer 240. The conveyer 240 may include a belt, auger, or the like which may be powered by a motor or the like 242. The conveyer 240 may include a plurality of sections 240a-240n which may be coupled together to extend to the end-user's site.

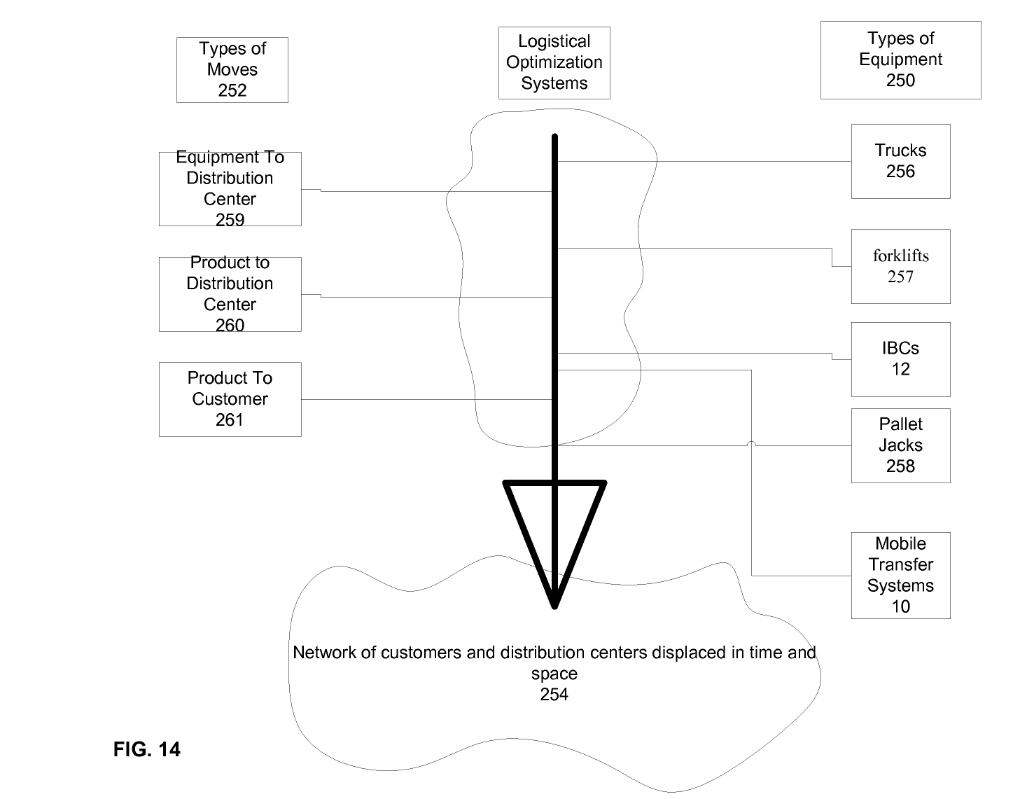

Turning now to FIGS. 14-17, the present disclosure may feature a method of distributing/delivering material 13 from a plurality of distribution centers to a plurality of customers (e.g., end-user sites) utilizing the mobile transfer system as described herein. For example, FIG. 14 schematically illustrates the resources/equipment 250, types of moves 252, and distribution routes 254 associated with the method. In particular, the method may utilize a plurality of resources/equipment 250 such as, but not limited to, trucks 256, forklifts 257 (e.g., but not limited to, truck mounted forklifts and the like), pallet jacks 258, IBCs 12, and the mobile transfer system 10 as described herein. The types of moves associated with the method may include moving equipment to distribution center(s) 259, moving product (e.g., material 13) to distribution centers 260, and moving product (e.g., material 13) to customers (e.g., end-user sites). The method may include optimizing the logistics associated with the resources/equipment 250 and types of moves 252 based on the distribution routes 254.

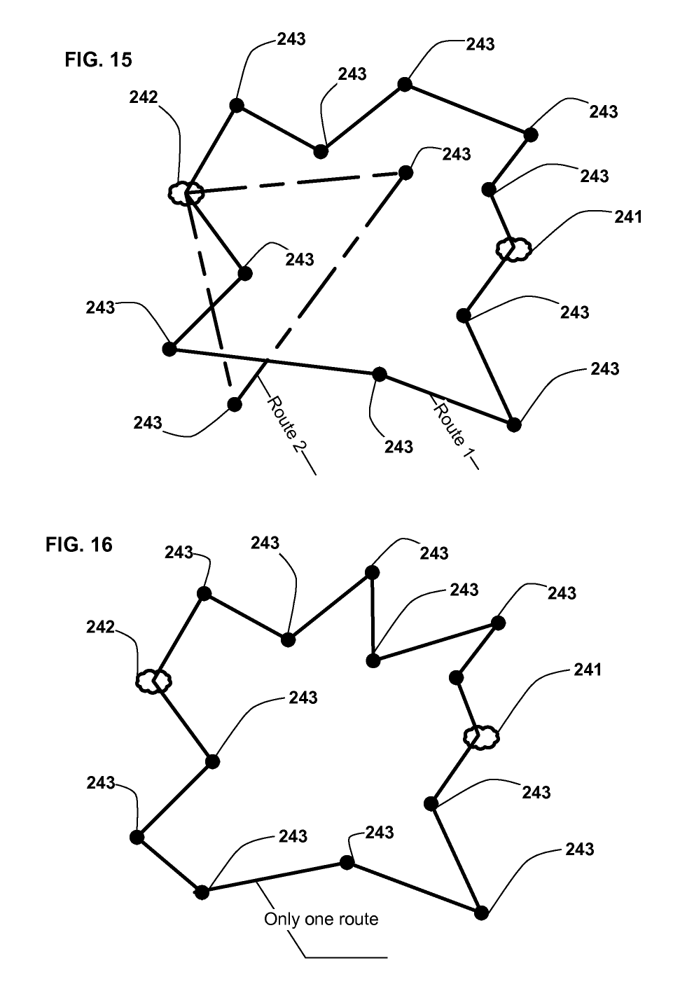

Traditional distribution methods (as generally illustrated in FIG. 15) may include a plurality of distribution centers 241, 242 and a plurality of customers 243a-n. Bulk deliveries may be handled in separate deliveries than the other product deliveries. This results from limitations in current equipment and equipment utilization. For example, a given set of deliveries may be initiated from distribution center 241 and may be associated with a single route (e.g., distribution center 241 may be associated with route 1 represented by the solid line) while a separate, different set of deliveries may be initiated from distribution center 242 (and follow route 2 represented by the dotted line). Routes 1 and 2 may be associated with different geographical locations (e.g., different customers 243) and/or different materials 13 (e.g., distribution center 241 may be associated with one type of material such as wood pellets while distribution center 242 may be associated with another material and/or grade or products). Moreover, since distribution centers 241, 242 are not linked by the various routes, each distribution center 241, 242 may need its own dedicated equipment 250 in order to accommodate the various types of moves 252. This results from the fact that bulk deliveries require different equipment from deliveries of the other products.

In contrast, the method associated with the present disclosure (FIG. 16) may optimize the equipment 250 in order to accommodate the various types of moves 252 such that each distribution center 241, 242 does not need its own dedicated equipment 250 and bulk deliveries 13 may be made simultaneously with other products on the same truck 256. In particular, the equipment 250 (such as, but not limited to, the IBCs 12, forklifts 257, pallet jacks 258 and/or mobile transfer systems 10) may be configured to be removably coupled to the trucks 256. The customers 243a-n may be serviced by a single route (represented by the solid line) which may include a plurality of distribution centers 241, 242. As such, as a truck 256 enters a distribution center 241, 242, the equipment 250 associated with that truck 256 (such as, but not limited to, the IBCs 12, forklifts 257, pallet jacks 258 and/or mobile transfer systems 10) may be added and/or removed. For example, a mobile transfer systems 10 and/or an IBC 12 may be removed from a first truck 256 and coupled to another truck 256, which may then service a plurality of customers 243a-n while the first truck 256 may service other customers 243a-n.

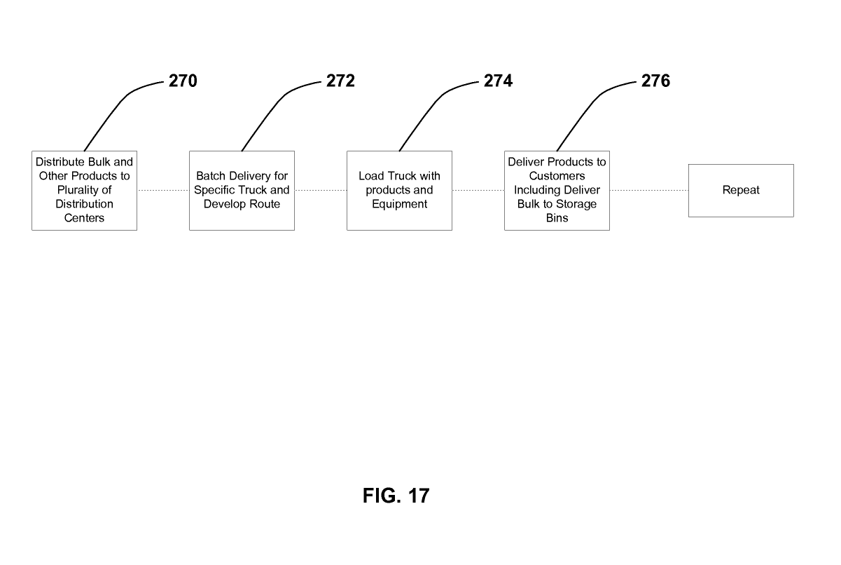

Turning now to FIG. 17, a method may comprise distributing bulk material 13 and optionally other products to a plurality of distribution centers (270). The material 13 may be separated in to batch deliveries for specific trucks and routes may be developed (272). For example, one or more types of bulk material 13 may be loaded into one or more IBCs 12. One or more of the IBCs 12 may then be loaded onto a truck 256 (274). Additionally, other equipment 250 may be loaded onto the truck 256 and/or other products (e.g., products other than bulk materials 13 may be comingled with the bulk material on the truck 256). The trucks 256 may then deliver the bulk materials 13 in the IBCs and/or other products to various customers (e.g., bulk materials 13 may be transferred to end-user sites using the mobile transfer systems 10 described herein) and/or other distribution centers (276). The process may then be repeated as necessary and equipment 250 may be transferred between trucks 256 and/or delivery routes as needed.

According to one aspect, the present disclosure may feature a mobile transfer system for transferring a bulk solid material stored within an intermediate bulk container. The mobile transfer system may comprise a blower configured to provide a flow of pressurized air, a hopper configured to be coupled to the intermediate bulk container, an entrainer, and a delivery hose. The hopper may be configured to be coupled to the intermediate bulk container and receive the bulk solid material from the intermediate bulk container. The entrainer may be configured to receive the bulk solid material from the hopper and to receive the flow of pressurized air. The entrainer may be further configured to entrain the bulk solid material within the flow of pressurized air and to provide at least partial pneumatic isolation of the hopper from the flow of pressurized air. The delivery hose configured to be coupled to the entrainer and to receive the entrained bulk solid material and the pressurized air and transfer the bulk solid material to an end-user storage site.

According to another aspect, the present disclosure may feature a system for transporting a bulk solid biomass fuel. The system may comprise at least one intermediate bulk container (IBC) and a mobile transfer system. The IBC may be configured to contain a quantity of bulk solid material. The mobile transfer system may be configured to transfer the bulk solid material from the IBC to an end-user site. The mobile transfer system may comprise a blower configured to provide a flow of pressurized air; a hopper configured to be coupled to the intermediate bulk container, the hopper configured to receive the bulk solid material from the intermediate bulk container; an entrainer configured to receive the bulk solid material from the hopper and to receive the flow of pressurized air, the entrainer further configured to entrain the bulk solid material within the flow of pressurized air and to provide at least partial pneumatic isolation of the hopper from the flow of pressurized air; and a delivery hose configured to be coupled to the entrainer and to receive the entrained bulk solid material and the pressurized air and transfer the bulk solid material to an end-user storage site.

According to yet a further aspect, the present disclosure may feature a method of transferring a bulk solid material. The method may comprise providing a flow of pressurized air; transferring bulk solid material from an intermediate bulk container (IBC) through a hopper to an entrainer while pneumatically isolating the hopper from the flow of pressurized air; entraining the bulk solid material with the flow of pressurized air in the entrainer; and transporting the entrained bulk solid material and the flow of pressurized air through a delivery hose to an end-user site.

While the principles of the present disclosure have been described herein, it is to be understood by those skilled in the art that this description is made only by way of example and not as a limitation as to the scope of the invention. The features and aspects described with reference to particular embodiments disclosed herein are susceptible to combination and/or application with various other embodiments described herein. Such combinations and/or applications of such described features and aspects to such other embodiments are contemplated herein. Other embodiments are contemplated within the scope of the present disclosure in addition to the exemplary embodiments shown and described herein. Modifications and substitutions by one of ordinary skill in the art are considered to be within the scope of the present invention, which is not to be limited except by the following claims.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified, unless clearly indicated to the contrary.

All references, patents and patent applications and publications that are cited or referred to in this application are incorporated in their entirety herein by reference.

Additional disclosure in the format of claims is set forth below:

What is claimed is:

1. A mobile transfer system for transferring a bulk solid material stored within an intermediate bulk container, said mobile transfer system comprising:
a blower configured to provide a flow of pressurized air;
a hopper configured to be coupled to said intermediate bulk container, said hopper configured to receive said bulk solid material from said intermediate bulk container;
an entrainer configured to receive said bulk solid material from said hopper and to receive said flow of pressurized air, said entrainer further configured to entrain said bulk solid material within said flow of pressurized air and to provide at least partial pneumatic isolation of said hopper from said flow of pressurized air; and
a delivery hose configured to be coupled to said entrainer and to receive said entrained bulk solid material and said pressurized air and transfer said bulk solid material to an end-user storage site.

2. The mobile transfer system according to claim 1, wherein said bulk solid material comprises a bulk solid biomass fuel.

3. The mobile transfer system according to claim 2, wherein said bulk solid biomass fuel comprises wood pellets.

4. The mobile transfer system according to claim 1, wherein said bulk solid material comprises animal bedding.

5. The mobile transfer system according to claim 1, wherein said entrainer further comprises an airlock disposed between said hopper and said delivery hose and wherein said mobile transfer system further comprises a feed valve or an auger disposed between said airlock and said hopper configured to control flow of bulk solid material between said hopper and said chamber.

6. The mobile transfer system according to claim 5, further comprising a chamber between said airlock and said delivery hose, wherein said chamber is configured to entrain said solid bulk material with said pressurized air.

7. The mobile transfer system according to claim 6, wherein said blower is configured to provide said flow of pressurized air to said delivery hose though said chamber.

8. The mobile transfer system according to claim 1, further comprising a frame, said frame configured to support said intermediate bulk container above said hopper and for aligning an outlet of said intermediate bulk container with said hopper.

9. The mobile transfer system according to claim 8, further comprising at least one adjustment mechanism for adjusting the level of said mobile transfer system to facilitate flow of the bulk solid material from said intermediate bulk container into said hopper.

10. The mobile transfer system according to claim 9, wherein said frame is removably coupled to a vehicle.

11. The mobile transfer system according to claim 1, further comprising a load measuring mechanism configured to provide a measurement of the quantity of bulk solid material delivered to said end-user site.

12. The mobile transfer system according to claim 1, further comprising a hose reel configured to store said deliver hose.

13. The mobile transfer system according to claim 1, wherein a plurality of intermediate bulk containers are configured to be nested on top another above said hopper.

14. The mobile transfer system according to claim 1, further comprising a classifier configured to separate fine particles from the bulk solid biomass material.

15. The mobile transfer system according to claim 14, wherein said classifier comprises a horizontal classifier.

16. The mobile transfer system according to claim 14, wherein said classifier comprises a pipe having a perforated portion configured to allow said fine particles to pass while preventing said bulk solid material from passing, said perforated portion coupled to a vacuum source.

17. The mobile transfer system according to claim 14, wherein said classifier comprises a vertical classifier.

18. The mobile transfer system according to claim 1, further comprising a vacuum mobile transfer system, said vacuum mobile transfer system configured to provide a vacuum to remove bulk solid material from said end-user storage bin.

19. The mobile transfer system according to claim 18, wherein said vacuum mobile transfer system further comprises an engine coupled to wheels for transporting said vacuum mobile transfer system.

20. The mobile transfer system according to claim 19, wherein said vacuum mobile transfer system further comprises:
a cyclonic separator configured to separate bulk solid material from fine using vortex separation;
an end-user vacuum hose configured to be coupled between said end-user site and a cyclonic separator
an airlock configured to receive the bulk solid material from said cyclonic separator;
a source vacuum hose configured to be coupled to cyclonic separator through a first stage filter, said source vacuum hose configured to be coupled to a blower through a filter silencer;
a chamber configured to be coupled to said blower, said chamber coupled to said airlock and a receiving hose, said receiving hose configured to be coupled to said end-user's site.

21. A system for transporting a bulk solid material, said system comprising:
at least one intermediate bulk container (IBC), said IBC configured to contain a quantity of said bulk solid material; and
a mobile transfer system for transferring said bulk solid material from said IBC to an end-user site, said mobile transfer system comprising:
a blower configured to provide a flow of pressurized air;
a hopper configured to be coupled to said intermediate bulk container, said hopper configured to receive said bulk solid material from said intermediate bulk container;
an entrainer configured to receive said bulk solid material from said hopper and to receive said flow of pressurized air, said entrainer further configured to entrain said bulk solid material within said flow of pressurized air and to provide at least partial pneumatic isolation of said hopper from said flow of pressurized air; and
a delivery hose configured to be coupled to said entrainer and to receive said entrained bulk solid material and said pressurized air and transfer said bulk solid material to an end-user storage site.

22. The system according to claim 21, further comprising a vehicle and wherein said mobile transfer system further comprises a frame, said frame configured to be removably coupled to said vehicle and to support said intermediate bulk container above said hopper and for aligning an outlet of said intermediate bulk container with said hopper.

23. The system according to claim 22, wherein the IBC is integral to said vehicle.

24. A method of transferring a bulk solid material comprising:
providing a flow of pressurized air;
transferring bulk solid material from an intermediate bulk container (IBC) through a hopper to an entrainer while pneumatically isolating said hopper from said flow of pressurized air;
entraining said bulk solid material with said flow of pressurized air in said entrainer; and
transporting said entrained bulk solid material and said flow of pressurized air through a delivery hose to an end-user site.
